(19) United States
(12) Patent Application Publication
(10) Pub. No.: US 2015/0118580 A1
(43) Pub. Date: Apr. 30, 2015

(54) Electrolyte for Non-Aqueous Electrolyte Battery, and Non-Aqueous Electrolyte Battery Using Same

(71) Applicant: Central Glass Company, Limited, Ube-shi, Yamaguchi (JP)

(72) Inventors: Yuki Kondo, Kawagoe-shi (JP); Makoto Kubo, Ube-shi (JP); Takayoshi Morinaka, Ube-shi (JP); Kenta Yamamoto, Ube-shi (JP)

(21) Appl. No.: 14/407,690

(22) PCT Filed: Jun. 10, 2013
(86) PCT No.: PCT/JP2013/066004

§ 371 Date: Dec. 12, 2014

(30) Foreign Application Priority Data
Jun. 13, 2012 (JP) 2012-133553
May 20, 2013 (JP) 2013-105746
May 20, 2013 (JP) 2013-105784
Jun. 7, 2013 (JP) 2013-120485

(51) Int. Cl. H01M 10/0567; H01M 10/0525; H01M 10/0569

(52) U.S. Cl. CPC H01M 10/0567; H01M 10/0569; H01M 10/0525
USPC 429/338; 429/200; 429/342; 429/337; 429/341; 429/340; 429/324

(57) ABSTRACT

What is disclosed is a non-aqueous electrolyte for non-aqueous electrolyte battery including a non-aqueous solvent and at least lithium hexafluorophosphate as a solute. This electrolyte is characterized by containing at least one siloxane compound represented by the general formula (1) or the general formula (2). This electrolyte has a storage stability which is improved than electrolytes prepared by adding conventional siloxane compounds.

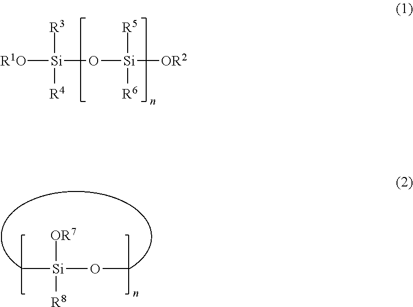

### TECHNICAL FIELD

The present invention relates to an electrolyte for non-aqueous electrolyte battery, which constitutes a non-aqueous electrolyte secondary battery superior in cycle characteristic and in the effect of suppressing the increase of internal resistance, and a non-aqueous electrolyte battery using the same.

### BACKGROUND OF THE INVENTION

Recently, electrical storage systems for information-related equipment or telecommunication equipment, i.e., electrical storage systems for equipment having a small size and requiring a high energy density, such as personal computers, video cameras, digital still cameras and cellular phones, as well as electrical storage systems for equipment having a large size and requiring a high electric power, such as electric automobiles, hybrid vehicles, auxiliary power supplies for fuel cell vehicles and electricity storages, have been attracting attentions.

Many of these non-aqueous electrolyte batteries have already been put to practical use. There occur, however, the decrease of electric capacitance and the increase of internal resistance by repeating charging and discharging. For such reason, the performance of non-aqueous electrolyte batteries has some problems in an application requiring a prolonged use, such as power source of motor vehicles.

Until now, as a means for improving various properties of non-aqueous electrolyte batteries, optimizations of various battery components including the active materials of the cathode and the anode have been examined. Non-aqueous electrolyte related-technologies are not their exception, either. Various additives have been proposed. Among them, adding a silicon compound to the electrolyte has been considered. For example, in Patent Publication 1, there has been proposed a method of improving the cycle characteristic by adding tetramethyl silicate to the electrolyte. In Patent Publication 2, there has been proposed an electrolyte obtained by adding an organic silicon compound having a Si—N bond(s). Also, in Patent Publications 3-7, additives having a siloxane (—Si—O—Si—) structure have been proposed.

### PRIOR ART PUBLICATIONS

### Patent Publications

Patent Publication 1: Japanese Patent Application Publication 10-326611

Patent Publication 2: Japanese Patent Application Publication 11-016602

Patent Publication 3: Japanese Patent Application Publication 8-078053

Patent Publication 4: Japanese Patent Application Publication 2002-134169

Patent Publication 5: Japanese Patent Application Publication 2004-071458

Patent Publication 6: Japanese Patent Application Publication 2007-141831

Patent Publication 7: Japanese Patent Application Publication 2010-092748

### SUMMARY OF THE INVENTION

The additives described in Patent Publications 1 and 2 can suppress the deterioration of the battery to some degree. It was, however, not enough for the cycle characteristic. Furthermore, there were the improvements of cycle characteristic and of output characteristic by suppressing the increase of internal resistance, by the additives having a siloxane structure described in Patent Publications 3-7. On the other hand, these siloxane compounds are easily decomposed by a reaction with lithium hexafluorophosphate as a solute of the electrolyte, thereby causing the change of the concentration of lithium hexafluorophosphate, too. Therefore, the electrolyte product was unstable. A buttery using this electrolyte had a defect of having a variation in its battery characteristic and therefore was not sufficiently satisfactory.

In electrolytes prepared by adding a siloxane compound, which are capable of demonstrating a superior cycle characteristic and the effect of suppressing the increase of internal resistance (hereinafter, may be described as “internal resistance characteristic”), the present invention provides an electrolyte for non-aqueous electrolyte batteries, in which storage stability after preparing an electrolyte product as having been a task can be improved as compared with electrolytes prepared by adding conventional siloxane compounds, and provides a non-aqueous electrolyte battery using this.

That is, in case that a siloxane compound of a specific structure is added to an electrolyte, and then the resulting electrolyte is used for a non-aqueous electrolyte battery, the present invention provides an electrolyte for non-aqueous electrolyte batteries, in which superior cycle characteristic and internal resistance characteristic can be demonstrated, and storage stability of the electrolyte product can be improved by suppressing reactivity with lithium hexafluorophosphate, as compared with electrolytes prepared by adding conventional siloxane compounds, and provides a non-aqueous electrolyte battery using this.

In view of such a problem, as a result of an ardent study, in case that a specific siloxane compound is contained in a non-aqueous electrolyte for non-aqueous electrolyte batteries, which contains a non-aqueous solvent and a lithium hexafluorophosphate-containing solute, and then the resulting electrolyte is used for a non-aqueous electrolyte battery, the present inventors have found that superior cycle characteristic and internal resistance characteristic can be demonstrated and that it becomes possible to suppress reactivity of the siloxane compound with lithium hexafluorophosphate and thereby storage stability of the electrolyte product can be improved as compared with electrolytes prepared by adding conventional siloxane compounds, thereby reaching the present invention.

That is to say, the present invention provides a non-aqueous electrolyte for non-aqueous electrolyte battery containing a non-aqueous solvent and a solute, the non-aqueous electrolyte for non-aqueous electrolyte battery containing at least lithium hexafluorophosphate as the solute, the electrolyte for non-aqueous electrolyte battery (hereinafter it is described simply as “non-aqueous electrolyte” or “electrolyte” in some cases) being characterized by containing at least one siloxane compound represented by the general formula (1) or the general formula (2).

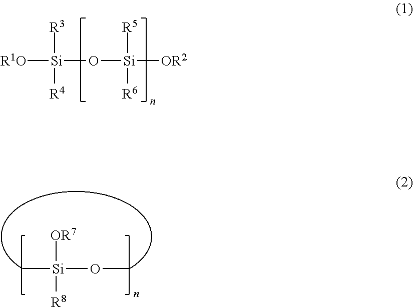

[In the general formula (1) and the general formula (2), each of R¹, R² and R⁷ independently represents a group that contains at least one fluorine atom and is selected from the group consisting of an alkyl group, an alkenyl group, an alkynyl group, and an aryl group, and these groups may have an oxygen atom. Each of R³-R⁶ and R⁸ independently represents a group selected from the group consisting of an alkyl group, an alkoxy group, an alkenyl group, an alkenyloxy group, an alkynyl group, an alkynyloxy group, an aryl group and an aryloxy group, and these groups may contain a fluorine atom and an oxygen atom. Furthermore, “n” represents an integer of 1-10. In case that “n” is 2 or greater, a plural number of R⁵, R⁶, R⁷ or R⁸ may be identical with each other or different from each other.]

Although these alkyl group, alkoxy group, alkenyl group, alkenyloxy group, alkynyl group, and alkynyloxy group are not particularly limited in the number of carbon, it is ordinarily 1-6 in view of easiness of availability of the raw material. In particular, it is possible to preferably use a group having a carbon number of 1-3. Moreover, in case that the number of carbon is 3 or greater, it is also possible to use one having a branched chain or cyclic structure.

As “aryl” moiety of the aryl group and the aryloxy group, an unsubstituted phenyl group is preferable from the viewpoint of easiness of availability. It is also possible to use one in which a group selected from the group consisting of an alkyl group, an alkoxy group, an alkenyl group, an alkenyloxy group, an alkynyl group, and an alkynyloxy group (the number of carbon is not limited, but the typical number of carbon is 1-6) has been substituted at an arbitrary position of the phenyl group.

Specifically, the case that these groups have a fluorine atom refers to one in which a hydrogen atom in these groups has been replaced with a fluorine atom.

Furthermore, specifically, as the case that these groups have an oxygen atom, it is possible to cite a group in which “—O—” (ether linkage) is interposed between carbon atoms of these groups.

In the above siloxane compound represented by the general formula (1) or the general formula (2), it is important to have an alkoxy group containing a fluorine atom(s), such as one represented by —OR¹ and —OR² or —OR⁷, as an essential structure. By having the structure, storage stability of the siloxane compound in the electrolyte is improved.

It is preferable that the addition amount of the above siloxane compound represented by the general formula (1) and the general formula (2) is within a range of 0.01-5.0 mass % to the total amount of the non-aqueous electrolyte for non-aqueous electrolyte battery.

Furthermore, in the above general formula (1) and general formula (2), it is preferable that each of the groups represented by R¹, R² and R⁷ is independently a group selected from 2,2-difluoroethyl group, 2,2,2-trifluoroethyl group, 2,2,3,3-tetrafluoropropyl group, 2,2,3,3,3-pentafluoropropyl group, 1,14-trifluoroisopropyl group, and 1,1,1,3,3,3-hexafluoroisopropyl group.

Furthermore, in the above general formula (1) and general formula (2), it is preferable that each of the groups represented by R³-R⁶ and R⁸ is independently a group selected from methyl group, ethyl group, vinyl group and aryl group.

Furthermore, the above solute may include a solute besides lithium hexafluorophosphate. As other solutes, it is possible to cite lithium tetrafluoroborate (LiBF₄), lithium bis(fluorosulfonyl)imide (LiN(FSO₂)₂), lithium bis(trifluoromethanesulfonyl)imide (LiN(CF₃SO₂)₂), lithium difluorophosphate (LiPO₂F₂), lithium difluoro(bis(oxalataphosphate (LiPF₂(C₂O₄)₂), lithium tetrafluoro(oxalato)phosphate (LiPF₄(C₂O₄)), lithium difluoro(oxalato)borate (LiBF₂(C₂O₄)) and lithium bis(oxalato)borate (LiB(C₂O₄)₂). It is preferable to make at least one of these solutes coexist with lithium hexafluorophosphate.

Furthermore, it is preferable that the above non-aqueous solvent is at least one non-aqueous solvent selected from the group consisting of cyclic carbonates, chainlike carbonates, cyclic esters, chainlike esters, cyclic ethers, chainlike ethers, sulfones or sulfoxide compounds and ionic liquids.

Furthermore, in a non-aqueous electrolyte battery having at least a cathode, an anode and an electrolyte for non-aqueous electrolyte battery, the present invention provides a non-aqueous electrolyte battery characterized in that the electrolyte for non-aqueous electrolyte battery is the above-mentioned electrolyte for non-aqueous electrolyte battery.

### Effect of the Invention

By the present invention, in a non-aqueous electrolyte for non-aqueous electrolyte battery including a non-aqueous solvent and a solute including lithium hexafluorophosphate, a particular siloxane compound is included. With this, when the electrolyte is used in a non-aqueous electrolyte battery, it is capable of demonstrating a superior cycle characteristic and a superior internal resistance characteristic. Besides, storage stability of the electrolyte product can be improved by suppressing reactivity of the siloxane compound with lithium hexafluorophosphate, as compared with electrolytes prepared by adding conventional siloxane compounds. Furthermore, it is possible to decrease a variation of a battery characteristic found in non-aqueous electrolyte batteries using electrolytes including conventional siloxane compounds.

### DETAILED DESCRIPTION

Hereinafter, although the present invention is explained in detail, the description of constituent elements mentioned below is an example of embodiments of the present invention. Therefore, it is not limited to these concrete contents. It can be implemented by transforming in various ways within its main point.

In a non-aqueous electrolyte for non-aqueous electrolyte battery including a non-aqueous solvent and a solute including lithium hexafluorophosphate, the non-aqueous electrolyte for non-aqueous electrolyte battery of the present invention is characterized by including at least one siloxane compound represented by the above general formula (1) or general formula (2) in the electrolyte.

In the above general formula (1) or general formula (2), as an alkyl group including at least one fluorine atom represented by R¹, R² or R⁷, it is possible to cite a C₂₋₆ alkyl group such as 2,2-difluoroethyl group, 2,2,2-trifluoroethyl group, 2,2,3,3-tetrafluoropropyl group, 2,2,3,3,3-pentafluoropropyl group, 1,14-trifluoroisopropyl group, 1,1,1,3,3,3-hexafluoroisopropyl group, etc. As the alkenyl group, it is possible to cite a C₂₋₆ alkenyl group such as fluoroisopropenyl group, difluoroisopropenyl group, fluoroallyl group, difluoroallyl group, etc. As the alkynyl group, it is possible to cite a C₂₋₈ alkynyl group such as 1-fluoro-2-propynyl group, 1,1-trifluoromethyl-2-propynyl group, etc. As the aryl group, it is possible to cite a C₆₋₁₂ aryl group such as fluorophenyl group, fluorotolyl group, fluoroxylyl group, etc.

In the above general formula (1) or general formula (2), as the alkyl group and the alkoxy group represented by R³—R⁶ and R⁸, it is possible to cite a C₁₋₁₂ alkyl group such as methyl group, ethyl group, propyl group, isopropyl group, butyl group, secondary butyl group, tertiary butyl group, pentyl group, etc. or an alkoxy group derived from these groups. As the alkenyl group and the alkenyloxy group, it is possible to cite a C₂₋₈ alkenyl group such as vinyl group, allyl group, 1-propenyl group, isopropenyl group, 2-butenyl group, 1,3-butadienyl group, etc. or an alkenyloxy group derived from these groups. As the alkynyl group and the alkynyloxy group, it is possible to cite a C₂₋₈ alkynyl group such as ethynyl group, 2-propynyl group, 1,1-dimethyl-2-propynyl group, etc. or an alkynyloxy group derived from these groups. As the aryl group and the aryloxy group, it is possible to cite a C₆₋₁₂ aryl group such as phenyl group, tolyl group, xylyl group, etc., and an aryloxy group.

As the siloxane compound represented by the above general formula (1) or general formula (2), more specifically, for example, it is possible to cite the following compounds No. 1-No. 15 and so on. However, the siloxane compounds used in the present invention are not limited at all by the following illustrations.

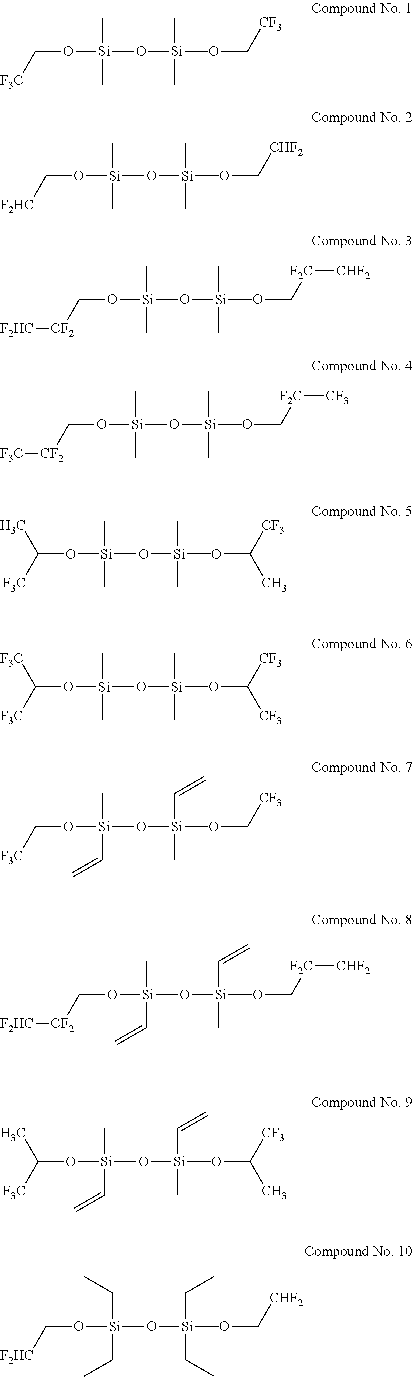

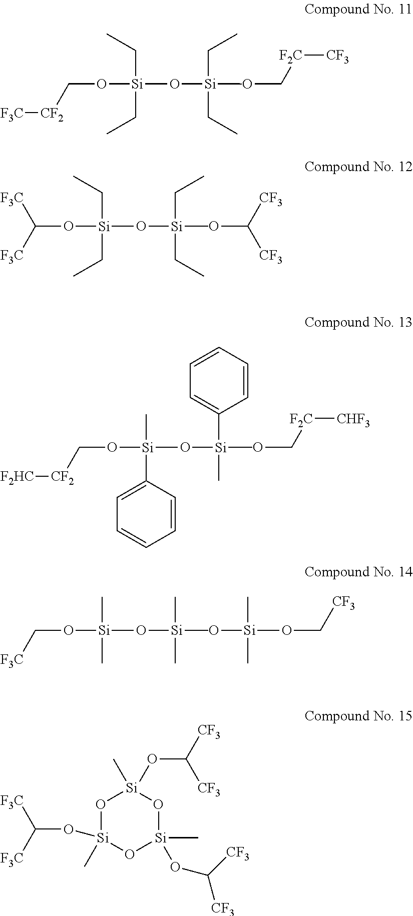

As being clear from these illustrations, in case of the siloxane of (1), because acquisition of compounds in which R¹ is equal to R² and furthermore R³, R⁴, R⁵ and R⁶ are all equal is easier, such siloxanes of the symmetrical structure are favorable illustrations from convenience in the synthesis. However, the use of asymmetrical siloxanes is not limited, either.

Furthermore, in the above general formula (1) or general formula (2), it is preferable that the group which is represented by R¹, R² or R⁷ includes two fluorine atoms or greater. In case of one fluorine atom, the electron-withdrawing property by the group represented by R¹, R² or R⁷ is weak, and thereby the effect of suppressing reaction with lithium hexafluorophosphate tends to be not sufficient.

In the above general formula (1) or general formula (2), it is preferable that the groups represented by R³-R⁶ and R⁸ are functional groups having a carbon number of 6 or less. In case of a functional group having a high carbon number, an internal resistance tends to be relatively large when forming a film on an electrode. In case of a functional group having a carbon number of 6 or less, the above internal resistance tends to be small. Therefore, it is preferable. In particular, if it is a group selected from methyl group, ethyl group, propyl group, vinyl group and phenyl group, it is possible to obtain a non-aqueous electrolyte battery superior in cycle characteristic and internal resistance property. Therefore, it is preferable.

Although it is not clear about the action mechanism of improvement of battery characteristics by the present invention, it is considered that the siloxane compounds in the present invention form decomposition films at interfaces between a cathode and an electrolyte and between an anode and an electrolyte. The films suppress direct contacts between a non-aqueous solvent or a solute and an active material to prevent the non-aqueous solvent and the solute from being decomposed. With this, deterioration of battery characteristics is suppressed. This effect has been found in electrolytes using conventional siloxane compounds, too. However, the conventional siloxane compounds react with lithium hexafluorophosphate which is a solute during storage of the electrolyte. Therefore, the siloxane compounds decompose to result in a loss of the battery characteristic improvement effect, and lithium hexafluorophosphate concentration also changes, thereby causing a problem that property of the electrolyte changes. The mechanism of improvement of storage stability of siloxane compounds in an electrolyte by the present invention is not clear. However, it is presumed that electrons on an oxygen atom inserted between silicon atoms dispersed by introducing an alkoxy group including a fluorine atom which becomes an electron-withdrawing group into the siloxane compound, and thereby reactivity with lithium hexafluorophosphate decreased greatly.

The addition amount of the siloxane compound used in the present invention is 0.01 mass % or greater, preferably 0.05 mass % or greater, more preferably 0.1 mass % or greater relative to the total amount of a non-aqueous electrolyte. Furthermore, its upper limit is 5.0 mass % or less, preferably 4.0 mass % or less, more preferably 3.0 mass % or less. In case that the above addition amount is less than 0.01 mass %, it is not preferable because the effect which improves cycle characteristic of a non-aqueous electrolyte battery using the non-aqueous electrolyte and which suppresses an increase of internal resistance is hard to obtain sufficiently. On the other hand, in case that the above addition amount is more than 5.0 mass %, it is not preferable because it is not only useless as not obtaining a further effect but also liable to cause deterioration of battery characteristic with the resistance increasing by an excessive film formation. In case of a range not to surpass 5.0 mass %, one kind may be used alone or two kinds or greater may be used after mixing at arbitrary combination and ratio to a use for these siloxane compounds.

The kinds of the non-aqueous solvent used in an electrolyte for non-aqueous electrolyte battery of the present invention is not particularly limited, and an arbitrary non-aqueous solvent can be used. As concrete illustrations, it is possible to cite cyclic carbonates such as propylene carbonate, ethylene carbonate, butylene carbonate, etc., chainlike carbonates such as diethyl carbonate, dimethyl carbonate, ethyl methyl carbonate, etc., cyclic esters such as γ-butyrolactone, γ-valerolactone, etc., chainlike esters such as methyl acetate, methyl propionate, etc., cyclic ethers such as tetrahydrofuran, 2-methyltetrahydrofuran, dioxane, etc., chainlike ethers such as dimethoxyethane, diethyl ether, etc., sulfones or sulfoxide compounds such as dimethyl sulfoxide, sulfolane, etc. Furthermore, although category is different from non-aqueous solvent, it is also possible to cite ionic liquids, etc. Furthermore, one kind may be used alone or two kinds or greater may be used after mixing at arbitrary combination and ratio to a use for non-aqueous solvent used in the present invention. Of these, from the viewpoint of electrochemical stability for the oxidation-reduction and chemical stability about heat and reactions with the above solutes, propylene carbonate, ethylene carbonate, diethyl carbonate, dimethyl carbonate and ethyl methyl carbonate are particularly preferable.

The kinds of other solutes which are made to coexist with lithium hexafluorophosphate used in the electrolyte for non-aqueous electrolyte battery of the present invention are not particularly limited, and it is possible to use a conventional well-known lithium salt. As concrete illustrations, it is possible to cite electrolyte lithium salts which are represented by LiBF₄, LiClO₄, LiAsF₆, LiSbF₆, LiCF₃SO₃, LiN(CF₃SO₂)₂, LiN(FSO₂)₂, LiN(C₂F₅SO₂)₂, LiN(CF₃SO₂)(C₄F₉SO₂), LiC(CF₃SO₂)₃, LiPF₃(C₃F₇)₃, LiB(CF₃)₄, LiBF₃(C₂F₅), LiPO₂F₂, LiPF₄(C₂O₄), LiPF₂(C₂O₄)₂, LiBF₂(C₂O₄), LiB(C₂O₄)₂, etc. For these solutes, one kind may be used alone or two kinds or greater may be used after mixing at arbitrary combination and ratio to a use. Among them, from the viewpoint of energy density, output characteristic, and life as a battery, LiBF₄, LiN(CF₃SO₂)₂, LiN(FSO₂)₂, LiN(C₂F₅SO₂)₂, LiPO₂F₂, LiPF₄(C₂O₄), LiPF₂(C₂O₄)₂, LiBF₂(C₂O₄) and LiB(C₂O₄)₂ are preferable.

Although there is no particular limitation about concentration of these solutes, its lower limit is a range of 0.5 mol/L or greater, preferably 0.7 mol/L or greater, more preferably 0.9 mol/L or greater. Furthermore, its upper limit is a range of 2.5 mol/L or less, preferably 2.0 mol/L or less, more preferably a range of 1.5 mol/L or less. In case that the concentration is less than 0.5 mol/L, cycle characteristic and output characteristic of the non-aqueous electrolyte battery tend to decrease by the decreases of ionic conductivity. On the other hand, in case that the concentration is more than 2.5 mol/L, there is also a tendency to make ionic conductivity decrease, and a risk to make cycle characteristic and output characteristic of non-aqueous electrolyte battery decrease by viscosity of the electrolyte for non-aqueous electrolyte battery increasing.

In case of dissolving a lot of solutes into the non-aqueous solvent at a time, temperature of the non-aqueous electrolyte may increase due to the heat of dissolution of the solute. When the solution temperature increases remarkably, there is a risk to generate hydrogen fluoride because decomposition of the fluorine-containing lithium salt is accelerated. Hydrogen fluoride is not preferable because of becoming a cause of deterioration of battery characteristic. Because of this, although the temperature of the non-aqueous electrolyte when dissolving the solute into the non-aqueous solvent is not particularly limited, it is preferable to be from −20 to 80° C. and more preferable to be from 0 to 60° C.

Although the above is an explanation about the basic structure of a non-aqueous electrolyte for non-aqueous electrolyte battery of the present invention, unless the main point of the present invention is spoiled, an additive generally used may be added to a non-aqueous electrolyte for non-aqueous electrolyte battery of the present invention at an arbitrary ratio. As concrete illustrations, it is possible to cite compounds having an overcharge prevention effect, an anode film forming effect, and a cathode protection effect, such as cyclohexylbenzene, biphenyl, t-butylbenzene, vinylene carbonate, vinyl ethylene carbonate, difluoroanisole, fluoroethylene carbonate, propane sultone, dimethylvinylene carbonate, etc. Furthermore, like the case to be used in a non-aqueous electrolyte battery which is called lithium polymer battery, it is also possible to use the electrolyte for non-aqueous electrolyte battery through coagulation by a gelling agent or a crosslinked polymer.

Next, structure of a non-aqueous electrolyte battery of the present invention is explained. The non-aqueous electrolyte battery of the present invention is characterized by using the above non-aqueous electrolyte for non-aqueous electrolyte battery of the present invention. For other constructional members, those used for general non-aqueous electrolyte batteries are used. That is to say, it consists of a cathode and an anode in which occlusion and release of lithium are possible, a collector, a separator, a case, etc.

The anode material is not particularly limited. It is possible to use lithium metal, alloys or intermetallic compounds of lithium and other metals and various carbon materials, artificial graphite, natural graphite, metal oxides, metal nitrides, tin (simple substance), tin compounds, silicon (simple substance), silicon compounds, activated carbons, electroconductive polymers, etc.

The cathode material is not particularly limited. In the case of lithium batteries and lithium ion batteries, it is possible to use, for example, lithium-containing transition metal composite oxides, such as LiCoO₂, LiNiO₂, LiMnO₂, and LiMn₂O₄, those in which a plurality of transition metals, such as Co, Mn and Ni, of those lithium-containing transition metal composite oxides have been mixed, those in which transition metals of those lithium-containing transition metal composite oxides have partially been replaced with other metals except transition metals, phosphate compounds of transition metals, called olivine, such as LiFePO₄, LiCoPO₄ and LiMnPO₄, oxides, such as TiO₂, V₂O₅ and M₀O₃, sulfides, such as TiS₂ and FeS, or electroconductive polymers, such as polyacetylene, polyparaphenylene, polyaniline and polypyrrole, activated carbons, radical-generating polymers, carbon materials, etc.

It is possible to make an electrode sheet by adding a conductive material, such as acetylene black, ketjen black, carbon fiber or graphite, and a binding material, such as polytetrafluoroethylene, polyvinylidene fluoride or SBR resin, to the cathode or anode material and then forming into a sheet shape.

As a separator to prevent contact of an anode and a cathode, non-woven fabrics and porous sheets which are made from polypropylene, polyethylene, paper, glass fiber etc. are usable.

A non-aqueous electrolyte battery whose type is a coin type, a cylindrical type, a square type, an aluminium laminate sheet type, etc. is constructed from the above each element.

### EXAMPLES

Hereinafter, the present invention is explained concretely according to its examples. However, the present invention is not limited by the examples.

### Example 1-1

In Table 1, preparation conditions of the non-aqueous electrolyte and evaluation results of storage stability of the electrolyte are shown. In Table 2, evaluation results of the battery using the electrolyte are shown. Also, each value of cycle characteristic and internal resistance characteristic of the battery in Table 2 is a relative value provided that each evaluation result of the initial electrical capacity and internal resistance of a laminate cell produced using electrolytes No. 1-37 before standing still for one month after preparation is taken as 100.

A non-aqueous electrolyte for non-aqueous electrolyte battery was prepared using a mixed solvent of ethylene carbonate and ethyl methyl carbonate having a volume ratio of 1:2 as a non-aqueous solvent, and dissolving LiPF₆ by 1.0 mol/L as a solute and the above siloxane compound No. 1 by 0.01 mass % as an additive into the solvent. Also, the above preparation was done while maintaining temperature of the electrolyte within a range of 20 to 30° C.

[Storage Stability Evaluation of Electrolyte]

After the prepared electrolyte was made to stand still for one month under argon atmosphere at 25° C., the residual amount of the above siloxane compound No. 1 in the electrolyte was measured. ¹H NMR method and ¹⁹F NMR method were used for the measurement of the residual amount.

[Electrochemical Characteristic Evaluation of Electrolyte]

A cell which included LiNi_{1/3}Mn_{1/3}CO_{1/3}O₂ as the cathode material and graphite as the anode material was made using an electrolyte before standing still for one-month after preparation and an electrolyte after standing still for one-month after preparation, and actually the cycle characteristic and the internal resistance of the battery were evaluated. The cell for testing was made as follows.

Polyvinylidene fluoride (PVDF) of 5 mass % as a binder and acetylene black of 5 mass % as a conducting agent were mixed to LiNi_{1/3}Mn_{1/3}CO_{1/3}O₂ powder of 90 mass %, followed by adding N-methylpyrrolidone to make a paste. A cathode body for testing was made through applying this paste on an aluminium foil and drying it. Furthermore, polyvinylidene fluoride (PVDF) of 10 mass % as a binder was mixed to graphite powder of 90 mass %, followed by adding N-methylpyrrolidone to make a slurry. An anode body for testing was made through applying this slurry on a copper foil and drying it for 12 hours at 120° C. Then, a separator made of polyethylene was impregnated with the electrolyte, and then a 50 mAh cell with an aluminium laminate outer package was constructed.

[High Temperature Cycle Characteristic]

Using the above cell, a charge-discharge test in an environmental temperature of 60° C. was implemented to evaluate its cycle characteristic. Both the charging and the discharging were implemented at a current density of 0.35 mA/cm², and there was repeated a charge-discharge cycle in which the charge was conducted by maintaining 4.3 V for one hour after reaching 4.3 V and in which the discharge was conducted until 3.0 V. Then, the condition of degradation of the cell was evaluated by discharge-capacity maintenance rate after 500 cycles (cycle characteristic evaluation). The discharge-capacity maintenance rate was determined by the following formula.

<Discharge-Capacity Maintenance Rate after 500 Cycles>

Discharge-capacity maintenance rate(%)=(Discharge capacity after 500 cycles/initial discharge-capacity)×100

[Internal Resistance Characteristic (25° C.)]

The cell after the cycle test was charged to 4.2 V at a current density of 0.35 mA/cm² at an environmental temperature of 25° C. Then, internal resistance of the battery was measured.

TABLE 1

| | | | | | | Residual amount of |
|---|---|---|---|---|---|---|
| | | Siloxane compound | | Other electrolytes except LiPF₆ | | siloxane compound |
| | Electrolyte | Compound | Concentration | | Concentration | after standing still |
| | No. | No. | (mass %) | Name | (mass %) | for one month (%) |
| Example 1-1 | 1-1 | No. 1 | 0.01 | None | 0 | 97 |
| Example 1-2 | 1-2 | No. 1 | 0.05 | | 0 | 96 |
| Example 1-3 | 1-3 | No. 1 | 0.1 | | 0 | 97 |
| Example 1-4 | 1-4 | No. 1 | 1 | | 0 | 98 |
| Example 1-5 | 1-5 | No. 2 | 1 | | 0 | 93 |
| Example 1-6 | 1-6 | No. 3 | 1 | | 0 | 96 |
| Example 1-7 | 1-7 | No. 4 | 1 | | 0 | 97 |
| Example 1-8 | 1-8 | No. 5 | 1 | | 0 | 92 |
| Example 1-9 | 1-9 | No. 6 | 0.5 | | 0 | 99 |
| Example 1-10 | 1-10 | No. 6 | 1 | | 0 | 98 |
| Example 1-11 | 1-11 | No. 6 | 2 | | 0 | 99 |
| Example 1-12 | 1-12 | No. 7 | 1 | | 0 | 97 |
| Example 1-13 | 1-13 | No. 7 | 3 | | 0 | 96 |
| Example 1-14 | 1-14 | No. 7 | 5 | | 0 | 96 |
| Example 1-15 | 1-15 | No. 8 | 1 | | 0 | 97 |
| Example 1-16 | 1-16 | No. 9 | 1 | | 0 | 94 |
| Example 1-17 | 1-17 | No. 10 | 1 | | 0 | 95 |
| Example 1-18 | 1-18 | No. 11 | 1 | | 0 | 96 |
| Example 1-19 | 1-19 | No. 12 | 0.5 | | 0 | 98 |
| Example 1-20 | 1-20 | No. 12 | 1 | | 0 | 98 |
| Example 1-21 | 1-21 | No. 13 | 1 | | 0 | 93 |
| Example 1-22 | 1-22 | No. 14 | 0.5 | | 0 | 91 |
| Example 1-23 | 1-23 | No. 14 | 1 | | 0 | 91 |
| Example 1-24 | 1-24 | No. 15 | 0.5 | | 0 | 97 |
| Example 1-25 | 1-25 | No. 15 | 1 | | 0 | 97 |
| Example 1-26 | 1-26 | No. 1 | 1 | Lithium difluorooxalatoborate | 1 | 96 |
| Example 1-27 | 1-27 | No. 1 | 1 | Lithium bis(oxalato)borate | 1 | 97 |
| Example 1-28 | 1-28 | No. 1 | 1 | Lithium difluorobis(oxalato)phosphate | 1 | 97 |
| Example 1-29 | 1-29 | No. 1 | 1 | Lithium tetrafluorooxalatophosphate | 1 | 98 |
| Example 1-30 | 1-30 | No. 1 | 1 | Lithium difluorophosphate | 1 | 97 |
| Example 1-31 | 1-31 | No. 2 | 1 | Lithium difluorooxalatoborate | 1 | 93 |
| Example 1-32 | 1-32 | No. 3 | 1 | Lithium bis(oxalato)borate | 1 | 94 |
| Example 1-33 | 1-33 | No. 4 | 1 | Lithium difluorobis(oxalato)phosphate | 1 | 96 |
| Example 1-34 | 1-34 | No. 5 | 1 | Lithium tetrafluoro(oxalato)phosphate | 1 | 97 |
| Example 1-35 | 1-35 | No. 6 | 1 | Lithium difluorophosphate | 1 | 92 |
| Example 1-36 | 1-36 | No. 7 | 1 | Lithium difluorobis(oxalato)phosphate | 1 | 99 |
| Comparative Example 1-1 | 1-37 | None | 0 | None | 0 | — |
| Comparative Example 1-2 | 1-38 | None | 0 | Lithium difluorobis(oxalato)phosphate | 1 | — |
| Comparative Example 1-3 | 1-39 | No. 16 | 0.5 | None | 0 | 52 |
| Comparative Example 1-4 | 1-40 | No. 16 | 1 | None | 0 | 46 |
| Comparative Example 1-5 | 1-41 | No. 17 | 0.5 | None | 0 | 32 |
| Comparative Example 1-6 | 1-42 | No. 18 | 1 | None | 0 | 19 |

### Examples 1-2-1-36

In Table 1, preparation conditions of the non-aqueous electrolytes and evaluation results of storage stability of the electrolytes are shown. In Table 2, evaluation results of batteries using the electrolytes are shown.

In the above Example 1-1, the kinds and the addition amounts of the siloxane compound and other electrolyte except lithium hexafluorophosphate (hereinafter, may be merely described as “other electrolyte”) were respectively changed, thereby preparing electrolytes for non-aqueous electrolyte batteries. Cells were made using the non-aqueous electrolytes as well as Example 1-1, and the battery evaluation was conducted.

### Comparative Examples 1-1-1-6

In Table 1, preparation conditions of the non-aqueous electrolytes and evaluation results of storage stability of the electrolytes are shown. In Table 2, evaluation results of batteries using the electrolytes are shown.

The electrolyte of Comparative Example 1-1 was prepared in the same manner as that of Example 1-1, except in that neither the siloxane compound nor other electrolyte was added. The electrolyte of Comparative Example 1-2 was prepared as well as above Example 1-1 except for not adding a siloxane compound and dissolving 1 mass % of lithium difluorobis(oxalato)phosphate which is other electrolyte. The electrolyte of Comparative Example 1-3-1-6 was prepared as well as Example 1-1 except for adding 0.5 mass % or 1.0 mass % of the following siloxane compound No. 16, No. 17 or No. 18 and not adding other electrolyte.

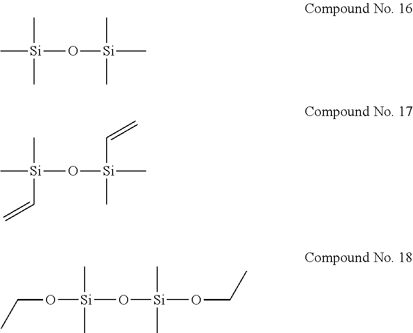

Comparing the above results, in case that the siloxane compounds include fluorine, residual amounts of the siloxane compound after standing still for one month indicated 90% or greater, and a high storage stability in an electrolyte was shown as compared with siloxane compounds not including fluorine. In evaluation result of battery using an electrolyte before standing still for one-month after preparation, siloxane compounds including fluorine indicated superior cycle characteristic and internal resistance that are equal to or greater than those of conventional siloxane compounds not including fluorine. Furthermore, comparing a battery characteristic using an electrolyte before standing still for one-month after preparation with that using an electrolyte after standing still for one-month after preparation, although a battery characteristic changed widely in case of using siloxane compounds not including fluorine, a difference was not seen mostly in case of using siloxane compounds including fluorine. Also with this, a high storage stability in an electrolyte using the siloxane compound including fluorine was indicated. Furthermore, also in case of using the siloxane compound together with other electrolytes, a high storage stability in the electrolyte using the siloxane compound including fluorine was confirmed. Regarding the battery characteristic, superior cycle characteristic and internal resistance which are equal to or greater than those of conventional siloxane compounds not including fluorine were shown. Therefore, it was shown to be able to obtain a non-aqueous electrolyte battery that is stable and superior in cycle characteristic and internal resistance characteristic even after standing still for one month after the preparation by using the electrolyte for non-aqueous electrolyte battery of the present invention.

### Examples 2-1-2-8, Comparative Examples 2-1-2-4

In Table 3, evaluation results of batteries prepared by changing the anode body used in Example 1-1 are shown. Also, in a combination of respective electrodes in Table 3, each value of cycle characteristic and internal resistance characteristic of batteries is a relative value provided that each evaluation result of the initial electrical capacity and internal resistance of a laminate cell produced using the electrolyte No. 1-37 before standing still for one month after preparation is taken as 100. Using the non-aqueous electrolyte No. 1-4, 1-10, 1-12, 1-20, 1-37 or 1-40 as the non-aqueous electrolyte for non-aqueous electrolyte battery, cycle characteristic and internal resistance were evaluated as well as Example 1-1. Also, in Examples 2-1-2-4, and Comparative Examples 2-1-2-2, whose anode active material is Li₄Ti₅O₁₂, its anode body was made through mixing polyvinylidene fluoride (PVDF) of 5 mass % as a binder and acetylene black of 5 mass % as a conducting agent into Li₄Ti₅O₁₂ powder of 90 mass %, followed by adding N-methylpyrrolidone and applying the obtained paste on a copper foil and drying it. Its end-of-charging voltage was set at 2.7 V and end-of-discharging voltage was set at 1.5 V in battery evaluation. Furthermore, in Example 2-5-2-8, and Comparative Example 2-3-2-4, whose anode active material is graphite (including silicon), its anode body was made through mixing silicon powder of 10 mass % and polyvinylidene fluoride (PVDF) of 10 mass % as a binder into graphite powder of 80 mass %, followed by adding N-methylpyrrolidone and applying the obtained paste on a copper foil and drying it. Its end-of-charging voltage and end-of-discharging voltage in battery evaluation were set similar to Example 1-1.

TABLE 2

| | | | | Electrolyte before 1 month | | Electrolyte after 1 month | |
|---|---|---|---|---|---|---|---|
| | | | | standing still | | standing still | |
| | | | | after preparation | | after preparation | |
| | | | | Capacity | | Capacity | |
| | | | Anode | maintenance | | maintenance | |
| | Electrolyte | Cathode Active | Active | rate after 500 | Internal | rate after 500 | Internal |
| | No. | Material | Material | cycles (%) | resistance | cycles (%) | resistance |
| Example 1-1 | 1-1 | LiNi₁/₃Co₁/₃Mn₁/₃O₂ | Graphite | 55 | 98 | 54 | 98 |
| Example 1-2 | 1-2 | | | 57 | 97 | 55 | 98 |
| Example 1-3 | 1-3 | | | 61 | 95 | 60 | 96 |
| Example 1-4 | 1-4 | | | 68 | 92 | 66 | 92 |
| Example 1-5 | 1-5 | | | 68 | 92 | 65 | 93 |
| Example 1-6 | 1-6 | | | 67 | 93 | 65 | 93 |
| Example 1-7 | 1-7 | | | 68 | 92 | 66 | 93 |
| Example 1-8 | 1-8 | | | 69 | 91 | 66 | 92 |
| Example 1-9 | 1-9 | | | 65 | 96 | 63 | 96 |
| Example 1-10 | 1-10 | | | 68 | 91 | 66 | 92 |
| Example 1-11 | 1-11 | | | 67 | 93 | 65 | 94 |
| Example 1-12 | 1-12 | | | 67 | 93 | 66 | 93 |
| Example 1-13 | 1-13 | | | 64 | 97 | 62 | 98 |
| Example 1-14 | 1-14 | | | 62 | 99 | 60 | 99 |
| Example 1-15 | 1-15 | | | 67 | 90 | 63 | 92 |
| Example 1-16 | 1-16 | | | 69 | 92 | 65 | 93 |
| Example 1-17 | 1-17 | | | 68 | 91 | 65 | 93 |
| Example 1-18 | 1-18 | | | 68 | 91 | 64 | 93 |
| Example 1-19 | 1-19 | | | 63 | 95 | 61 | 97 |
| Example 1-20 | 1-20 | | | 67 | 92 | 63 | 92 |
| Example 1-21 | 1-21 | | | 67 | 92 | 64 | 93 |
| Example 1-22 | 1-22 | | | 63 | 97 | 61 | 97 |
| Example 1-23 | 1-23 | | | 69 | 93 | 67 | 95 |
| Example 1-24 | 1-24 | | | 62 | 97 | 59 | 98 |
| Example 1-25 | 1-25 | | | 67 | 92 | 65 | 94 |
| Example 1-26 | 1-26 | | | 84 | 71 | 84 | 72 |
| Example 1-27 | 1-27 | | | 82 | 70 | 81 | 70 |
| Example 1-28 | 1-28 | | | 86 | 70 | 85 | 71 |
| Example 1-29 | 1-29 | | | 83 | 72 | 81 | 73 |
| Example 1-30 | 1-30 | | | 80 | 70 | 79 | 71 |
| Example 1-31 | 1-31 | | | 84 | 69 | 84 | 70 |
| Example 1-32 | 1-32 | | | 83 | 71 | 82 | 71 |
| Example 1-33 | 1-33 | | | 87 | 71 | 86 | 72 |
| Example 1-34 | 1-34 | | | 83 | 70 | 83 | 70 |
| Example 1-35 | 1-35 | | | 81 | 72 | 80 | 73 |
| Example 1-36 | 1-36 | | | 86 | 71 | 85 | 72 |
| Comparative Example 1-1 | 1-37 | | | 54 | 100 | 50 | 104 |
| Comparative Example 1-2 | 1-38 | | | 78 | 73 | 75 | 77 |
| Comparative Example 1-3 | 1-39 | | | 63 | 95 | 52 | 108 |
| Comparative Example 1-4 | 1-40 | | | 66 | 93 | 53 | 112 |
| Comparative Example 1-5 | 1-41 | | | 64 | 96 | 49 | 115 |
| Comparative Example 1-6 | 1-42 | | | 68 | 95 | 47 | 118 |

TABLE 3

| | | | | Electrolyte before 1 month | | Electrolyte after 1 month | |
|---|---|---|---|---|---|---|---|
| | | | | standing still | | standing still | |
| | | | | after preparation | | after preparation | |
| | | | | Capacity | | Capacity | |
| | | | Anode | maintenance | | maintenance | |
| | Electrolyte | Cathode Active | Active | rate after 500 | Internal | rate after 500 | Internal |
| | No. | Material | Material | cycles (%) | resistance | cycles (%) | resistance |
| Example 2-1 | 1-4 | LiNi₁/₃Co₁/₃Mn₁/₃O₂ | Li₄Ti₅O₁₂ | 69 | 92 | 66 | 93 |
| Example 2-2 | 1-10 | | | 70 | 91 | 67 | 92 |
| Example 2-3 | 1-12 | | | 68 | 93 | 67 | 93 |
| Example 2-4 | 1-20 | | | 68 | 92 | 65 | 93 |
| Comparative Example 2-1 | 1-37 | | | 56 | 100 | 53 | 103 |
| Comparative Example 2-2 | 1-40 | | | 67 | 93 | 52 | 114 |
| Example 2-5 | 1-4 | | Graphite | 63 | 93 | 61 | 93 |
| Example 2-6 | 1-10 | | (including | 64 | 93 | 61 | 95 |
| Example 2-7 | 1-12 | | silicon) | 62 | 92 | 60 | 93 |
| Example 2-8 | 1-20 | | | 64 | 93 | 60 | 93 |
| Comparative Example 2-3 | 1-37 | | | 48 | 100 | 45 | 107 |
| Comparative Example 2-4 | 1-40 | | | 64 | 94 | 43 | 113 |
| Example 3-1 | 1-4 | LiCoO₂ | Graphite | 68 | 92 | 65 | 92 |
| Example 3-2 | 1-10 | | | 68 | 91 | 66 | 93 |
| Example 3-3 | 1-12 | | | 67 | 92 | 65 | 93 |
| Example 3-4 | 1-20 | | | 67 | 92 | 64 | 92 |
| Comparative Example 3-1 | 1-37 | | | 54 | 100 | 51 | 104 |
| Comparative Example 3-2 | 1-40 | | | 65 | 92 | 50 | 115 |
| Example 4-1 | 1-4 | LiMn_{1.95}Al_{0.05}O₄ | Graphite | 65 | 93 | 63 | 94 |
| Example 4-2 | 1-10 | | | 66 | 92 | 63 | 93 |
| Example 4-3 | 1-12 | | | 64 | 92 | 62 | 94 |
| Example 4-4 | 1-20 | | | 65 | 92 | 63 | 93 |
| Comparative Example 4-1 | 1-37 | | | 52 | 100 | 49 | 105 |
| Comparative Example 4-2 | 1-40 | | | 64 | 94 | 47 | 116 |
| Example 5-1 | 1-4 | LiFePO₄ | Graphite | 71 | 94 | 70 | 95 |
| Example 5-2 | 1-10 | | | 70 | 93 | 68 | 93 |
| Example 5-3 | 1-12 | | | 71 | 93 | 69 | 95 |
| Example 5-4 | 1-20 | | | 71 | 94 | 68 | 95 |
| Comparative Example 5-1 | 1-37 | | | 60 | 100 | 58 | 103 |
| Comparative Example 5-2 | 1-40 | | | 70 | 94 | 54 | 110 |

### Examples 3-1-3-4, Comparative Examples 3-1-3-2

In Table 3, evaluation results of batteries prepared changing the cathode body used in Example 1-1 are shown. Using the non-aqueous electrolyte No. 1-4, 1-10, 1-12, 1-20, 1-37 or 1-40 as a non-aqueous electrolyte for non-aqueous electrolyte battery, cycle characteristic and internal resistance were evaluated as well as Example 1-1. A cathode body whose cathode active material is LiCoO₂ was made through mixing polyvinylidene fluoride (PVDF) of 5 mass % as a binder and acetylene black of 5 mass % as a conducting agent into LiCoO₂ powder of 90 mass %, followed by adding N-methylpyrrolidone and applying the obtained paste on an aluminium foil and drying it. Its end-of-charging voltage was set at 4.2 V and end-of-discharging voltage was set at 3.0 V in battery evaluation.

### Examples 4-1-4-4, Comparative Examples 4-1-4-2

In Table 3, evaluation results of batteries prepared by changing the cathode body used in Example 1-1 are shown. Using the non-aqueous electrolyte No. 1-4, 1-10, 1-12, 1-20, 1-37 or 1-40 as a non-aqueous electrolyte for non-aqueous electrolyte battery, cycle characteristic and internal resistance were evaluated as well as Example 1-1. A cathode body whose cathode active material is LiMn_{1.95}Al_{0.0504} was made through mixing polyvinylidene fluoride (PVDF) of 5 mass % as a binder and acetylene black of 5 mass % as a conducting agent into LiMn_{1.95}Al_{0.0504} powder of 90 mass %, followed by adding N-methylpyrrolidone and applying the obtained paste on an aluminium foil and drying it. Its end-of-charging voltage was set at 4.2 V and end-of-discharging voltage was set at 3.0 V in battery evaluation.

### Examples 5-1-5-4, Comparative Examples 5-1-5-2

In Table 3, evaluation results of batteries prepared by changing the cathode body used in Example 1-1 are shown. Using the non-aqueous electrolyte No. 1-4, 1-10, 1-12, 1-20, 1-37 or 1-40 as a non-aqueous electrolyte for non-aqueous electrolyte battery, cycle characteristic and internal resistance were evaluated as well as Example 1-1. A cathode body whose cathode active material is LiFePO₄ was made through mixing polyvinylidene fluoride (PVDF) of 5 mass % as a binder and acetylene black of 5 mass % as a conducting agent into LiFePO₄ powder of 90 mass % which was covered with amorphous carbon, followed by adding N-methylpyrrolidone and applying the obtained paste on an aluminium foil and drying it. Its end-of-charging voltage was set at 4.1 V and end-of-discharging voltage was set at 2.5 V in battery evaluation.

As described above, in each Example using LiCoO₂, LiMn_{1.95}Al_{0.0504} or LiFePO₄ as a cathode active material, it was confirmed that cycle characteristic and internal resistance of a laminate cell using the electrolyte for non-aqueous electrolyte battery of the present invention is superior to the corresponding Comparative Example. Therefore, using the electrolyte for non-aqueous electrolyte battery of the present invention, it was shown that regardless of kinds of the cathode active material, even in case of using an electrolyte after standing still for one-month after preparation, it is possible to obtain a non-aqueous electrolyte battery that is stable and has superior cycle characteristic and internal resistance characteristic like the case of using an electrolyte before standing still for one-month after preparation.

Furthermore, as described above, even in each Example using Li₄Ti₅O₁₂ or graphite (including silicon) as an anode active material, it was confirmed that cycle characteristic and internal resistance of a laminate cell using the electrolyte for non-aqueous electrolyte battery of the present invention is superior to the corresponding Comparative Example. Therefore, using the electrolyte for non-aqueous electrolyte battery of the present invention, it was shown that regardless of kinds of the anode active material, even in case of using an electrolyte after standing still for one-month after preparation, it is possible to obtain a non-aqueous electrolyte battery that is stable and has superior cycle characteristic and internal resistance characteristic like the case of using an electrolyte before standing still for one-month after preparation.

1.-7. (canceled)

8. A non-aqueous electrolyte for a non-aqueous electrolyte battery comprising
a non-aqueous solvent,
a solute, wherein the solute comprises at least lithium hexafluorophosphate,
and at least one siloxane compound represented by the general formula (1) or the general formula (2): 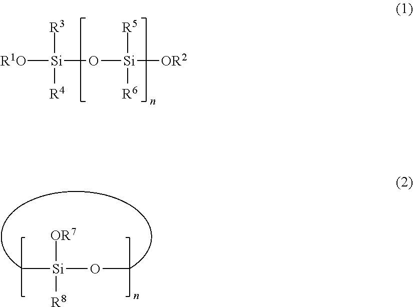
wherein, for the general formula (1) and the general formula (2), each of R¹, R² and R⁷ independently represents a group that contains at least one fluorine atom and is selected from the group consisting of an alkyl group, an alkenyl group, an alkynyl group, and an aryl group, wherein these groups may have an oxygen atom.
wherein each of R³-R⁶ and R⁸ independently represents a group selected from the group consisting of an alkyl group, an alkoxy group, an alkenyl group, an alkenyloxy group, an alkynyl group, an alkynyloxy group, an aryl group and an aryloxy group, and wherein these groups may contain a fluorine atom and an oxygen atom, and
wherein n represents an integer of 1-10.

9. The electrolyte for non-aqueous electrolyte battery of claim 8, wherein each of the groups represented by R¹, R² and R⁷ in the above general formula (1) and general formula (2) is independently a group selected from the group consisting of 2,2-difluoroethyl group, 2,2,2-trifluoroethyl group, 2,2,3,3-tetrafluoropropyl group, and 1,1,1,3,3,3-hexafluoroisopropyl group.

10. The electrolyte for non-aqueous electrolyte battery of claim 8, wherein each of the groups represented by R³-R⁶ and R⁸ in the above general formula (1) and general formula (2) is independently a group selected from the group consisting of a methyl group, an ethyl group, a vinyl group and an aryl group.

11. The electrolyte for non-aqueous electrolyte battery of claim 8, wherein the siloxane compound represented by the general formula (1) or the general formula (2) is a compound represented by one of the following chemical formulas,

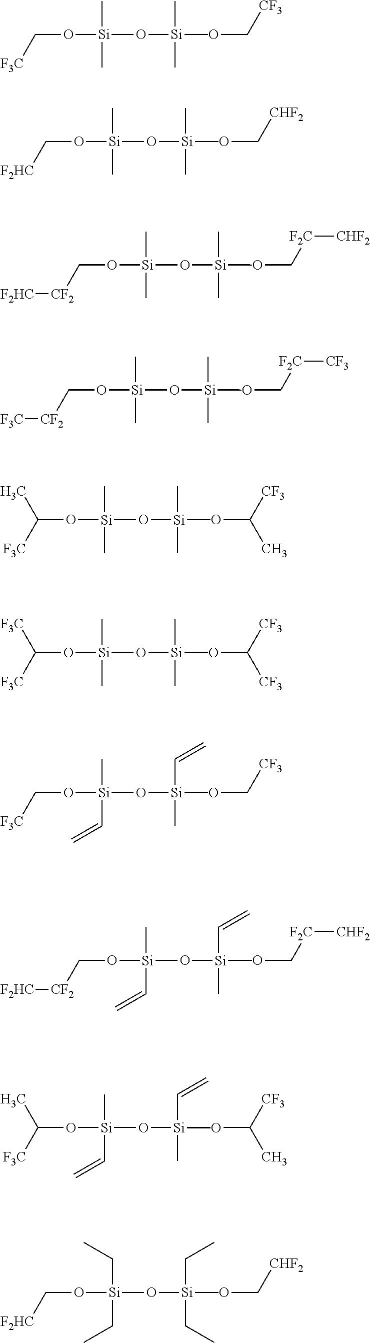

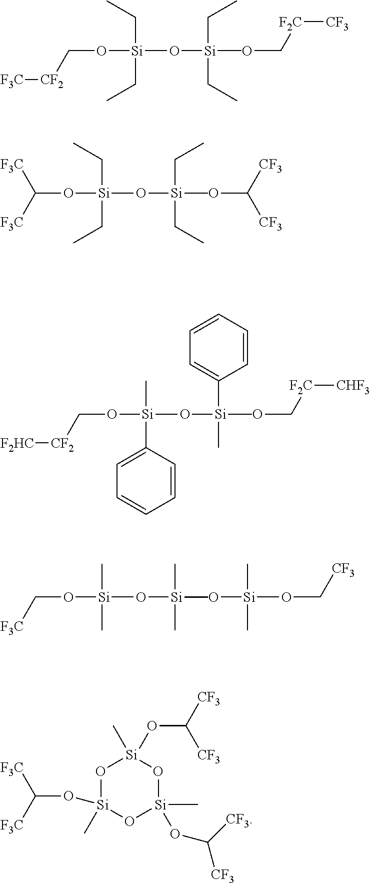

12. The electrolyte for non-aqueous electrolyte battery of claim 8, wherein at least one solute is selected from the group consisting of lithium tetrafluoroborate (LiBF₄), lithium bis(fluorosulfonyl)imide (LiN(FSO₂)₂), lithium bis(trifluoromethanesulfonyl)imide (LiN(CF₃SO₂)₂), lithium difluorophosphate (LiPO₂F₂), lithium difluoro(bis(oxalato))phosphate (LiPF₂(C₂O₄)₂), lithium tetrafluoro(oxalato)phosphate (LiPF₄(C₂O₄)), lithium difluoro(oxalato)borate (LiBF₂(C₂O₄)) and lithium bis(oxalato)borate (LiB(C₂O₄)₂), and wherein the solute is made to coexist with lithium hexafluorophosphate.

13. The electrolyte for non-aqueous electrolyte battery of claim 8, wherein the concentration of the solute is in a range of 0.5 mol/L-2.5 mol/L.

14. The electrolyte for non-aqueous electrolyte battery of claim 8, wherein the non-aqueous solvent is at least a solvent selected from the group consisting of cyclic carbonates, chainlike carbonates, cyclic esters, chainlike esters, cyclic ethers, chainlike ethers, sulfones or sulfoxide compounds, and ionic liquids.

15. The electrolyte for non-aqueous electrolyte battery of claim 8, wherein the non-aqueous solvent is at least a solvent selected from the group consisting of propylene carbonate, ethylene carbonate, diethyl carbonate, dimethyl carbonate and ethyl methyl carbonate.

16. The electrolyte for non-aqueous electrolyte battery of claim 8, wherein the addition amount of the siloxane compound represented by the general formula (1) or the general formula (2) is in a range of 0.01-5.0 mass % to total amount of the electrolyte for non-aqueous electrolyte battery.

17. A non-aqueous electrolyte battery equipped with at least a cathode, an anode and an electrolyte for non-aqueous electrolyte battery, wherein an electrolyte for non-aqueous electrolyte battery is the electrolyte for non-aqueous electrolyte battery according to claim 8.
